(19) United States
(12) Patent Application Publication
(10) Pub. No.: US 2004/0128368 A1
(43) Pub. Date: Jul. 1, 2004

(54) Information processing apparatus, network device control method, program for implementing the control method, and storage medium storing the program

(75) Inventor: Masahiko Sakai, Kanagawa (JP)

Correspondence Address: Marc A. Rossi, ROSSI & ASSOCIATES, P.O. Box 826, Ashburn, VA, 20146-0826, US

(73) Assignee: CANON KABUSHIKI KAISHA, Tokyo (JP)

(21) Appl. No.: 10/652,855

(22) Filed: Aug. 29, 2003

(30) Foreign Application Priority Data
Aug. 30, 2002 (JP) 2002-254282 (PAT.

(51) Int. Cl. G06F 15/177

(52) U.S. Cl. 709/220

(57) ABSTRACT

There is provided an information processing apparatus which is capable of configuring and resetting a network device by using network management software prepared as utility software provided with a single program reset function independent of device types. The settings of a device on a network are configured by the network management software, and then it is determined whether or not remote reset of the device is possible to carry out (S4 to S6). If remote reset of the device is possible to carry out, the same is executed, whereas if remote reset of the device is impossible to carry out, a message promoting the user to restart power supply to the device is displayed.

### BACKGROUND OF THE INVENTION

1. Field of the Invention

The present invention relates to an information processing apparatus that controls network devices connected to a network, a network device control method, a program for implementing the control method, and a storage medium storing the program.

2. Description of the Related Art

Recently, local area networks (LANs) in which computers are interconnected have come to be widely used. Such a local area network is constructed over a floor or the entirety of a building, a group of buildings (an enclosure), a local area, or a larger area. In some cases, such networks are interconnected, or connected to a worldwide network. These local area networks allow numerous computers, such as PCs (personal computers), and numerous devices, such as printers, to be connected to them. In such interconnected LANs, various techniques for interconnecting hardware devices and apparatuses and a plurality of network protocols are used.

In a simple isolated LAN, each user can manage devices and apparatuses. That is, the user can change (add, remove or replace) devices and apparatuses, install software, or check problems.

In a simple LAN which is disconnected from other networks, individual users can perform apparatus management, that is, users can replace devices or apparatuses with other devices or apparatuses, install software, and diagnose problems or faults, for example.

However, in a large-scale complicated LAN or a large group of interconnected LANs, “management” is required. The term “management” means both management by a human network manager and management by software that the manager uses. In the present specification, “management” means management by network management software for managing the entire system, and “user” means a person who uses network management software. The user is usually a person responsible for system management. By using network management software, the “user” can obtain management data on the network and change the data.

A large-scale network system is a dynamic system which always requires addition or removal of devices or apparatuses, updating of software, detection of problems, and the like. In general, various systems possessed by various people and supplied by various suppliers exist as such a large-scale network system.

Various methods for managing network devices on a network constituting such a large-scale network system have been provided by many standardization organizations. The International Organization for Standardization (ISO) has provided a general-purpose standard framework called an Open System Interconnection (OSI) model. The OSI model of a network control protocol is called a Common Management Information Protocol (CMIP). The CMIP is a common network management protocol used in Europe.

Recently, a modified protocol relating to the CMIP called a Simple Network Management Protocol (SNMP) has been used as a network management protocol which can be more commonly used.

According to the SNMP network management technique, a network management system includes at least one network management station (NMS), a plurality of nodes to be managed, each having an agent, and a network management protocol used by the management station or the agents for exchange of management information. By communicating with agent software of a node to be managed using network management software of the NMS, the user can obtain management data on the network and change the data.

The term “agent” means software running as a background process at each node to be managed. When the user requests management data from a node to be managed on the network, the network management software causes an object identifier, referred to hereinafter, to be included in a management packet or frame, and transmits the resulting data to the agent of the node to be managed.

The agent interprets the object identifier and obtains data corresponding to the object identifier. The agent causes the data to be included in the packet and transmits the resultant data to the network management software. In some cases, the agent calls a corresponding process in order to obtain the data.

The agent also holds data relating to the node to be managed in the form of a database. This database is called an MIB (management information base).

FIG. 9 illustrates the concept of the structure of the MIB. As shown in FIG. 9, the MIB has a data structure in the form of a tree, where an identifier is uniquely provided for each node. In FIG. 9, the identifier for a node is defined based on the number written in the parentheses. For example, the identifier for a node 201 is “1”. A node 202 is a child of the node 201, and therefore the identifier for the node 202 is “l·3”. Similarly, the identifier for a node 203 is “1·3·6·1·2”. Such an identifier for a node is an object identifier. In FIG. 9, a part of the MIB defined as a standard is extracted and shown.

The structure of the MIB is called Structure of Management Information (SMI), and is defined by RFC(Request for Comments)1155 “Structure and Identification of Management Information for TCP/IP-based Internets”.

A node 204, which is called a standard MIB, is normally provided in devices managed by the SNMP, and is the top node of an object group. The detailed structure of objects ranked below this node is specified in “RFC1213 Management Information Base for Network Management of TCP/IP-based internets: MIB-II”.

A node 205, which is called a printer MIB, is normally provided in printers managed by the SNMP, and is the top node of an object group. The detailed structure of objects ranked below this node is specified in “RFC1759 Printer MIB”.

A node 206, which is called a private MIB, is a top node used by a company or an organization for defining its own MIB.

A node 207, which is called a company expansion MIB, is a top node used by a company for performing its own expansion within the private MIB. The present assignee, Canon Inc. has been assigned “1602” as a company number for performing autonomous definition, and a top node 208 for defining a MIB (Canon MIB) unique to Canon Inc., which is ranked at a position below the node 207, indicates the company. The object identifier for the top node of the Canon MIB is “1·3 ·6·1·4·1·1602”.

Now, a case where setting of a network device (e.g. a printer) is executed using network management software in the above-described system will be considered.

When settings of a device are changed, in some cases, reset of the device or restart of power supply to the device is required to enable the new settings. Further, some devices allow remote reset from the network management software, but others do not. In a device of the latter type, it is necessary to turn off its power switch and then turn it on again (i.e. restart the power supply).

However, insofar as the above conventional network management software is concerned, it is necessary to prepare a program depending on the type of a device, i.e. whether the device is a type which can be remotely reset for enabling settings using MIB or a type which requires a user to manually restart its power supply for the same purpose (in the case of the former type, it is necessary to prepare a utility software program provided with a reset capability), which has necessitated large development costs.

On the other hand, in a printing system under the network environment widely used recently, it is supposed that printer devices of various models including new ones and old ones are used. Under such an environment, it is envisaged that there are various reset methods employed by printer devices for changing settings (configuring) of the devices and then resetting the devices to enable the new settings. Therefore, a user needs to reset a device according to a reset method suitable for the device, and hence needs to learn in advance about correspondence between each device and a reset method. Further, since reset methods are different from device to device, it is necessary to install a utility software program for execution of reset thereof on a device-by-device basis in advance.

### SUMMARY OF THE INVENTION

It is an object of the invention to provide an information processing apparatus which is capable of configuring and resetting a network device by using network management software prepared as utility software provided with a single program reset function independent of device types, a network device control method, a program for implementing the control method, and a storage medium storing the program.

To attain the above object, in a first aspect of the invention, there is provided an information processing apparatus capable of communicating with network devices each provided with a recording device for recording data on a recording medium, comprising a configuring device that gives a configuring instruction to a network device to be controlled, from a remote site, to thereby cause the network device to be configured, a reset instruction device that gives a remote reset instruction to the network device to be controlled, and a display control device that causes a message requesting restart of power supply to the network device and an indication of a successful remote reset to be selectively displayed on a display, based on response information output from the network device in response to the remote reset instruction given by the reset instruction device.

With the arrangement of the information processing apparatus according to the first aspect of the present invention, after configuring a device on the network, it is determined whether or not remote reset of the device is possible to carry out, and if the remote reset is possible to carry out, the remote reset is carried out, whereas if the remote reset is impossible to carry out, a message is displayed which prompts the user to restart power supply to the device. This makes it possible to prepare a program independent of the types of devices, that is, independent of whether the device is a type which can be remotely reset, or not.

Further, when the device is of a type which cannot be remotely reset, by displaying the message prompting the user to manually restart power supply to the device, it is possible to avoid a state of the device in which the settings thereof have been configured, but have not been enabled.

Therefore, even when there are printer devices employing various resetting methods on the network, it is possible to efficiently cope with such a situation.

Preferably, the information processing apparatus further comprises a reception device that receives the response information, and a determination device that determines, based on the response information, whether or not processing carried out in response to the remote reset instruction given to the network device has been successful.

More preferably, the determination device is responsive to reception by the reception device receiving information indicating that remote reset is not supported by the network device, as the response information, for determining that the processing carried out in response to the remote reset instruction has failed.

Further preferably, the determination device is responsive to the reception receiving information indicating that the network device is in a state incapable of carrying out remote reset, as the response information, for determining that the processing carried out in response to the remote reset instruction has failed, the network device supporting remote reset.

Even more preferably, the reset instruction device is responsive to the reception device receiving the information indicating that the network device is in the state incapable of carrying out remote reset, for giving the remote reset instruction to the network device again.

More preferably, the reset instruction device is responsive to the determination device determining that the processing carried out in response to the remote reset instruction has failed for giving the remote reset instruction to the network device again.

Further preferably, the reception device also receives an event issued upon termination of a job being processed by the network device, and the reset instruction device gives the remote reset instruction to the network device again in response to reception of the event.

More preferably, the display control device is responsive to the determination device determining that the processing carried out in response to the remote reset instruction has been successful, for causing a state of progress of reset processing in the network device to be displayed on the display.

Preferably, the determination device determines whether or not processing carried out in response to the configuring instruction given by the configuring device has failed, and the display control device causes different messages to be displayed on the display depending on whether the determination device determines that the processing carried out in response to the configuring instruction given by the configuring device has failed or that processing carried out in response to the remote set instruction has failed.

To attain the above object, in a second aspect of the invention, there is provided an information processing apparatus capable of communicating with network devices each provided with a recording device for recording data on a recording medium comprising a configuring device that gives a configuring to a network device to be controlled, from a remote site, a reset instruction device that gives a remote reset instruction to the network device to be controlled, in accordance with the configuring instruction by the configuring device, so as to enable configuring of the network device by the configuring device, a determination device that determines whether remote reset of the network device has failed or processing carried out by the network device in response to another instruction has failed; and a display control device to the determination device determining that remote reset of the network device has failed, for causing a message requesting restart of power supply to the network device to be displayed on a display.

With the arrangement of the information processing apparatus according to the second aspect of the present invention, it is possible to obtain the same advantageous effects as provided by the first aspect of the present invention.

Preferably, wherein the other instruction includes the configuring instruction given to the network device by the configuring device, and the display control device is responsive to the determination device determining that the processing carried out by the network device in response to the other instruction has failed, for causing a message indicating that configuring of the network device by the configuring device has failed, to be displayed on the display.

To attain the above object, in a third aspect of the invention, there is provided a network device control method comprising a configuring step of giving a configuring instruction to a network device to be controlled, from a remote site, to thereby cause the network device to be configured, a reset instruction step of giving a remote reset instruction to the network device to be controlled, and a display control step of causing a message requesting restart of power supply to the network device and an indication of a successful remote reset to be selectively displayed on a display, based on response information output from the network device in response to the remote reset instruction given in the reset instruction step.

With the arrangement of the network device control method according to the third aspect of the present invention, it is possible to obtain the same advantageous effects as provided by the first aspect of the present invention.

To attain the above object, in a fourth aspect of the invention, there is provided a network device control method comprising a configuring step of giving a configuring instruction to a network device to be controlled, from a remote site, a reset instruction step of giving a remote reset instruction to the network device to be controlled, in accordance with the configuring instruction given in the configuring step, so as to enable configuring of the network device, a determination step of determining whether or not remote reset of the network device has failed, and a display control step of causing a message requesting restart of power supply to the network device to be displayed on a display, when it is determined in the determination step that remote reset of the network device has failed.

With the arrangement of the network device control method according to the fourth aspect of the present invention, it is possible to obtain the same advantageous effects as provided by the first aspect of the present invention.

To attain the above object, in a fifth aspect of the invention, there is provided a program for causing a computer to execute the network device control method according to the third aspect of the invention.

With the arrangement of the program according to the fifth aspect of the present invention, it is possible to obtain the same advantageous effects as provided by the first aspect of the present invention.

To attain the above object, in a sixth aspect of the invention, there is provided a program for causing a computer to execute the network device control method according to the fourth aspect of the present invention.

With the arrangement of the program according to the sixth aspect of the present invention, it is possible to obtain the same advantageous effects as provided by the first aspect of the present invention.

To attain the above object, in a seventh aspect of the invention, there is provided a computer-readable storage medium storing the program according to the fifth aspect of the present invention.

With the arrangement of the computer-readable storage medium according to the seventh aspect of the present invention, it is possible to obtain the same advantageous effects as provided by the first aspect of the present invention.

To attain the above object, in an eighth aspect of the invention, there is provided a computer-readable storage medium storing the program according to the sixth aspect of the present invention.

With the arrangement of the computer-readable storage medium according to the eighth aspect of the present invention, it is possible to obtain the same advantageous effects as provided by the first aspect of the present invention.

The above and other objects, features, and advantages of the present invention will become more apparent from the following detailed description taken in conjunction with the accompanying drawings.

### BRIEF DESCRIPTION OF THE DRAWINGS

FIG. 1 is a diagram showing a system in which a network board for connecting a printer to a network is connected to a printer having an open type architecture;

FIG. 2 is a block diagram showing an example of the hardware configuration of a network device controller as an information processing apparatus according to an embodiment of the present invention;

FIG. 3 is a block diagram showing an example of the configuration of modules of network management software;

FIG. 4 is a flowchart showing a network device setting process which is executed mainly by the network device controller shown in FIG. 2, particularly a CPU thereof;

FIG. 5 is a diagram showing an example of a network setting sheet displayed on a CRT appearing in FIG. 2;

FIG. 6 is a diagram showing an example of a dialog box in which is displayed a message prompting a user to restart power supply to a device;

FIG. 7 is a diagram showing an example of a dialog box in which an error message is displayed;

FIG. 8 is a flowchart showing a process executed by a network device; and

FIG. 9 is a conceptual representation of the structure of an MIB.

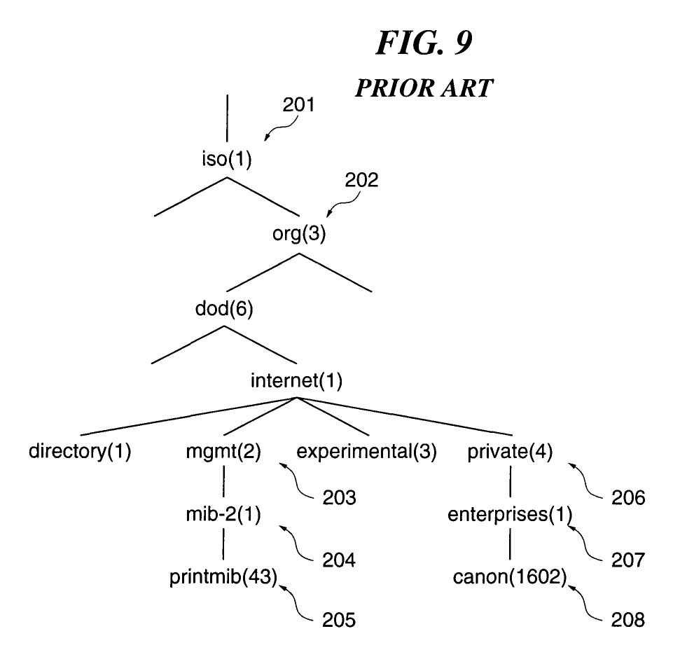

### DETAILED DESCRIPTION OF THE PREFERRED EMODIMENTS

The present invention will now be described in detail with reference to the drawings.

First, a description will be given of a large-scale network to which is connected a network device controller as an information processing apparatus according to an embodiment of the present invention.

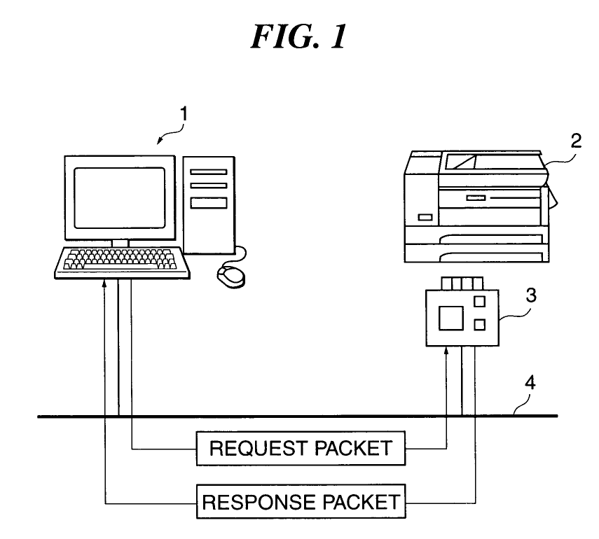

FIG. 1 shows a system in which a network board (NB) 3 for connecting a printer as an example of a network device to the network (LAN) 4 is connected to a printer 2 having an open type architecture.

In FIG. 1, the network board 3 is connected to the LAN 4 through a LAN interface, such as an Ethernet (Registered Trademark) interface 10 base-2 with a coaxial connector or a 10 Base-T with a RJ45 connector.

The network device in the present embodiment may be a printing apparatus using the electrophotographic printing method, an ink jet printer using the ink jet printing method, a digital multi-function machine provided with a copying function and a facsimile function, or a PC as an information processing apparatus.

The network device controller 1 (also referred to as the client) of the present embodiment, which is formed by a PC (information processing apparatus), is also connected to the LAN 4, and capable of communicating with the NB 3 under the control of a network operating system. In the network device controller 1, a network control program for managing the network is operating, and the network is controlled by the program.

A request packet and a response packet appearing in FIG. 1 will be described hereinafter.

Usually, a LAN provides service for a somewhat local user group, such as a user group on one floor or a plurality of consecutive floors within one building. A wide area network (WAN) may be constructed if users are at locations remote from each other, for example, when users are located in different buildings or different states. The WAN is basically an aggregate of some LANs formed by connecting the LANs via a high-speed digital line, such as a high-speed Integrated Services Digital Network (ISDN) or the like.

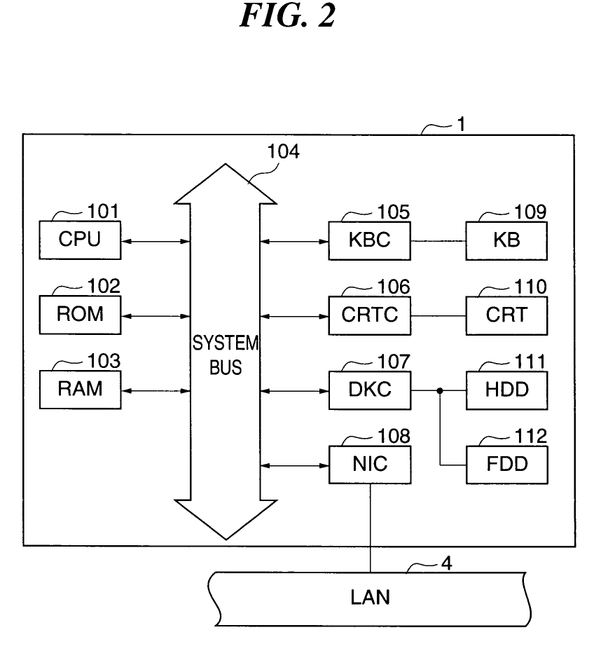

FIG. 2 is a block diagram showing an example of the hardware configuration of the network device controller 1.

In FIG. 2, the network device controller 1 is implemented by a PC operated by network management software and is identical to the controller 1 appearing in FIG. 1. The network device controller 1 includes a CPU 101 that executes the network management software stored in a ROM 102 or a hard disk drive (HDD) 111, or supplied by a flexible disk drive (FDD), and performs centralized control of devices connected to a system bus 104.

A RAM 103 is a main memory of the CPU 101, and functions as a working area and the like.

A keyboard controller (KBC) 105 controls input of instructions through a keyboard (KB) 109, a pointing device (not shown) and the like.

A CRT controller (CRTC) 106 controls display on a CRT display (CRT) 110.

A disk controller (DKC) 107 controls access to the hard disk drive (HDD) 111 and the flexible disk drive (FDD) 112, which store a boot program, various application programs, editing files, user files, the network management software and the like.

A network interface card (NIC) 108 bidirectionally exchanges data with agents or network apparatuses via the LAN 4.

The network management software is stored in the hard disk (HDD) 111. In the entirety of the following description, unless otherwise mentioned, hardware that executes the network management software as a program is the CPU 101, and software that performs the control is the network management software stored in the HDD 111. Although in the present embodiment, it is assumed that Windows (registered trademark; provided by Microsoft Corporation) is used as an OS (operating system), the OS is not limited to this software.

The network management software may be stored in and supplied from a storage medium, such as a flexible disk, a CD (compact disc)-ROM or the like. In this case, the program is read from the storage medium using the FDD 112, a CD-ROM drive (not shown) or the like, and is installed in the HDD 111.

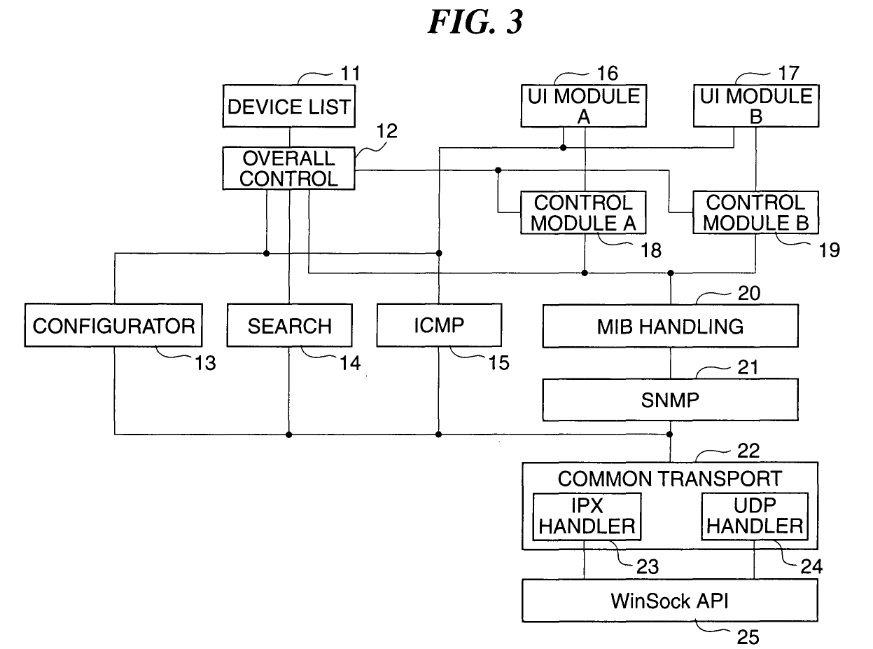

FIG. 3 is a diagram showing an example of the configuration of modules of the network management software. This network management software is stored in the HDD 111 and executed by the CPU 101. In executing the software, the CPU 101 uses the RAM 103 as a working area.

In FIG. 3, reference numeral 11 designates a device-list module, which displays a list of network devices connected to the network.

Reference numeral 12 designates an overall control module, which controls the other modules based on instructions from the device list module 11.

A configurator 13 is a module which performs special processing relating to network configuring by an agent. Particularly, when a network device in a state shipped from a factory is initially connected to a LAN, for example, the configurator 13 performs setting of the network device based on a special protocol, referred to hereinafter.

A search module 14 searches network devices connected to the network. A list of network devices searched by the search module 14 is displayed by the device-list module 11. An instruction for changing settings (configuring) and an instruction for remote reset are given to a network device selected from the list.

An ICMP module 15 performs control based on the ICMP (Internet Control Message Protocol). The ICMP is a TCP/IP control protocol defined by IETF RFC792 of IETF (Internet Engineering Task Force), and normally provided in a terminal or a device with the TCP/IP mounted thereon.

A UI (user interface) module A 16 and a UI module B 17 display a device detail window, referred to hereinafter. A UI module is provided for each network device whose detail information is to be displayed.

A control module A 18 and a control module B 19 perform control peculiar to each network device whose detail information is to be acquired. Similarly to the UI modules, a control module is provided for each network device whose detail information is to be acquired. The control modules A and B 18, 19 acquire MIB information from a network device to be managed using an MIB module 20, convert data of the MIB information if necessary, and deliver the data to the UI module A 16 and the UI module B 17 associated therewith.

The MIB module 20 performs conversion between an object identifier and an object key. The object key is a 32 bit integer which corresponds to an object identifier. The object identifier is a variable-length identifier. In the network management software according to the present invention, fixed-length identifiers corresponding respectively to object identifiers are internally used because it is troublesome to deal with a variable-length identifier when mounting the network management software. A module at a level higher than the MIB module 20 deals with the MIB information using the object key.

Reference numeral 21 represents an SNMP module, which transmits and receives an SNMP packet.

Reference numeral 22 represents a common transport module, which absorbs difference between the lower-level protocols for transporting the SNMP packet. Actually, one of an IPX (Internet Packet Exchange) handler 23 and a UDP (User Datagram-Protocol) handler 24 transfers a packet according to a protocol selected by the user when the network management software operates. To mount the UDP handler 24, WinSock 25 is used for Winsock (Windows Socket), see the specification of Windows (registered trademark) Socket API v1.1.

In the following, a description will be given of a procedure of operation of the network management software started on the PC 1, for making network configuring of the printer 2 and the network board 3.

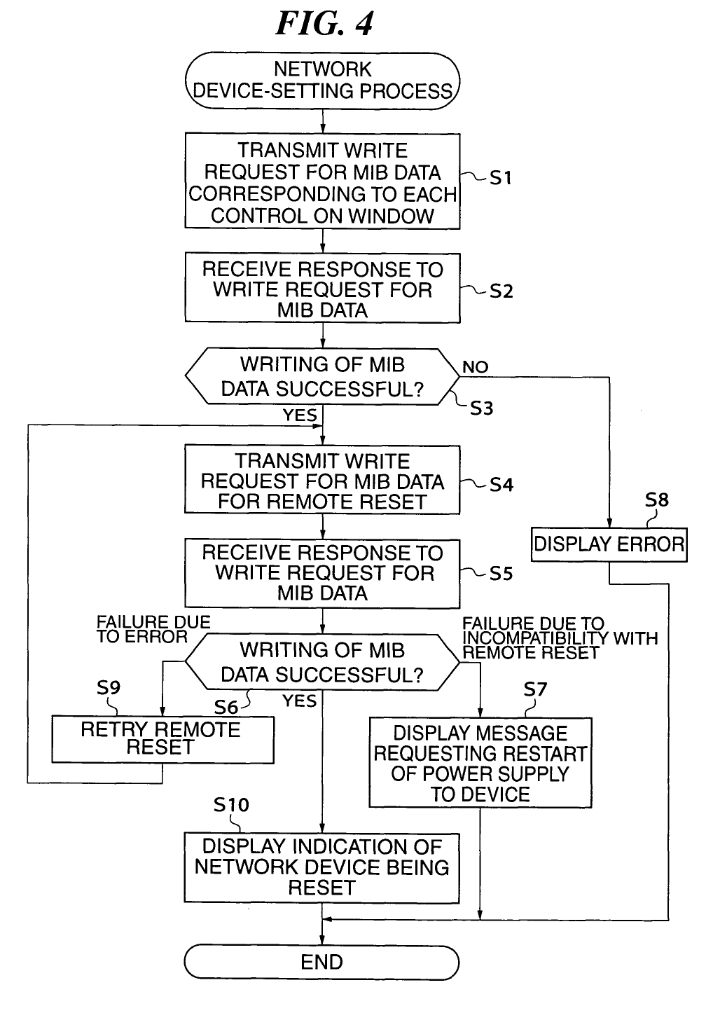

FIG. 4 is a flowchart showing a network device-setting process executed by the network device controller 1, for configuring a network device from a remote site, i.e. setting up of the network device. This process is carried out e.g. by the control modules A and B 18, 19 appearing in FIG. 3.

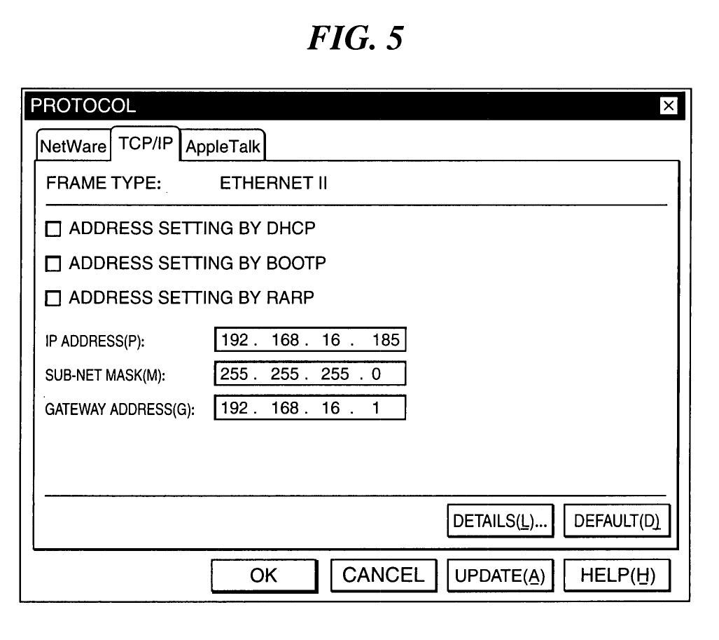

The present process is started when any of various configurations for a network device is instructed to be made by depressing an “OK” button or an “update” button on a network setup sheet, an example of which is shown in FIG. 5. More specifically, the user interface as illustrated in FIG. 5 is displayed on a display (corresponding to the CRT 110 in FIG. 2) provided in the client, and then, when a signal indicative of “OK” or “update” is input via a pointing device, such as a mouse or a keyboard (corresponding to the KB 109 in FIG. 2), steps shown in FIG. 4 are executed by the client in response to the signal.

In FIG. 5, an IP address, a sub-net mask, a gateway address, and so forth are shown as settings for the network device.

First, in a step S1, a write request requesting writing of MIB data corresponding to the controls (contents of a setting input via the network setup sheet) on the window (network setup sheet in FIG. 5) is transmitted. This write request corresponds to an instruction for setting a predetermined configuration item, such as a network configuration.

Then, when a response to the write request requesting writing of the MIB data is received in a step S2, the process proceeds to a step S3. Information received as the response from the network device indicates whether or not the network device is capable of meeting the write request requesting writing of the MIB data.

In the step S3, it is determined whether or not the writing of the MIB data has been successful. If it has been successful, the process proceeds to a step S4, whereas if the writing of the MIB data has failed, the process proceeds to a step S8. More specifically, when a set request (for writing an IP address in an MIB object to set the IP address) is transmitted from the client to the network device, and when the processing responsive to the set request has been successful, the device responds by sending a value “0” as an error status, which is indicative of no error, to the client. When receiving the value “0” as an error status, the client determines that the writing of the IP address in the MIB has been successful, whereas when receiving a value other than “0”, the client determines that the writing has failed.

In the step S4, a write request requesting writing of MIB data for execution of remote reset is transmitted. The step S4 in which a remote reset instruction is issued is executed in response to an affirmative answer (YES) to the question of the step S3. Although the user conventionally had to carry out an operation for remote reset after making a predetermined configuration of the network device, the step S4 makes the operation unnecessary and hence saves the user time and labor. Further, since the step S4 is executed in response to the affirmative answer (YES) to the question of the step S3, it is possible to prevent the user from inadvertently failing to reset the network device.

In a step S5, a response to the write request requesting writing of the MIB data for remote reset is received. Throughout the present specification, the term “reset” is intended to mean forcibly restarting a computer (device), and the term “remote reset” is intended to mean causing the reset to be executed, from a remote site via a communication line.

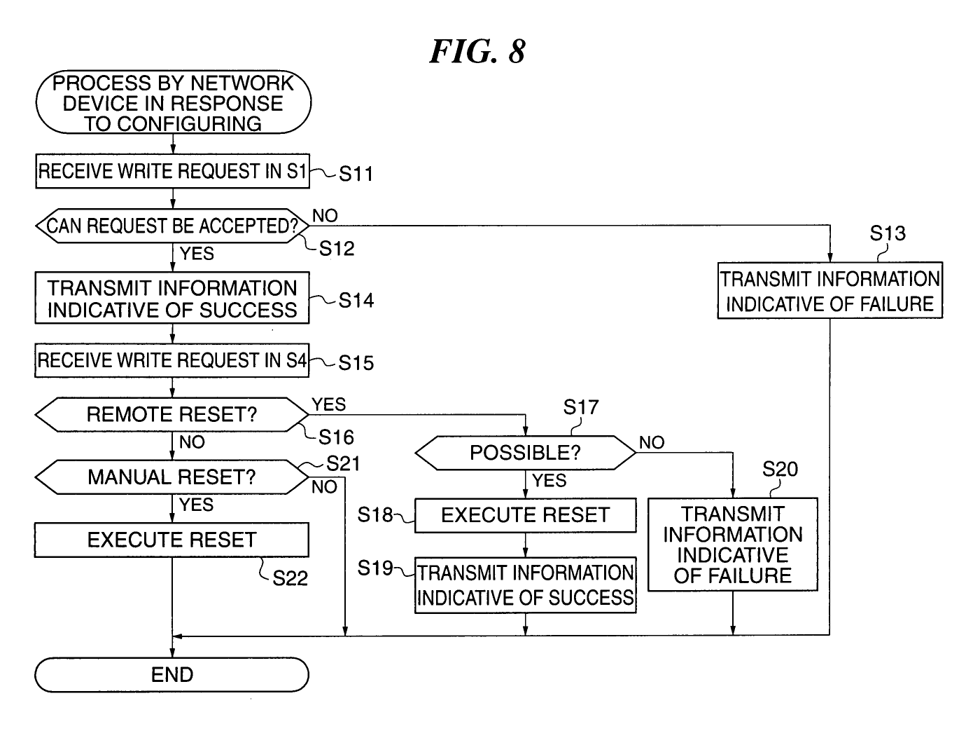

Then, the process proceeds to a step S6, wherein it is determined, based on the response received in the step S5, whether or not writing of the MIB data has been successful. More specifically, the determination is performed e.g. by referring to information indicative of whether or not the writing of the MIB data for remote reset corresponding to the step S4 has been successful (see a step S19 or S20 in FIG. 8, referred to hereinafter), which is transmitted from the network device in response to the write request of the step S4. When the writing has been successful, the device responds by sending a value of “0” as an error status. On the other hand, when the writing has failed, a value other than “0” is sent from the device. For example, when the device does not support the MIB object to which the set request has been sent from the client, a value of “2” indicating that there exists no object is sent from the device as an error status. The response of a value other than “0” corresponds to the network device sending as a response information indicating that remote reset is not supported. The response of the information indicating that remote reset is not supported is sent from the network device, when the network device is a legacy device, a cheap device, or a device in which inhibition of remote reset is set by the user.

If it is determined in the step S6 that the writing of the MIB data has been successful, this means that the configuring of the network device has been actually set in the network device, which completes the process for configuring of the network device. Then, in a step S10, an indication that the network device is being reset is displayed. For example, if a progress bar is used to display the state of progress of the reset, it is possible to inform the user that the network device is being reset, even when it takes several tens of seconds to several minutes to reset the network device.

On the other hand, if it is determined in the step S6 that the writing of the MIB data has failed, the process proceeds to a step S7 or S9. When it is determined in the step S6 that the writing of the MIB data has failed, it is determined whether the failure is due to incompatibility of the network device with the MIB object for remote reset, or due to an error (i.e. incapability of the remote reset) which has occurred despite the compatibility of the network device with the MIB for remote reset.

When a response indicative of incompatibility of the network device with the MIB is received from the network device, the process proceeds to the step S7, whereas when a response of an error is received from the network device, the process proceeds to the step S9. The response of an error corresponds to information indicating that although the remote reset is supported by the network device, the network device is in a state incapable of executing the remote reset.

The response of an error from the network device in the step S6 occurs, for example, when the network device is performing printing, test printing, or writing of predetermined data in an NVRAM (corresponding to the RAM 103 in FIG. 2).

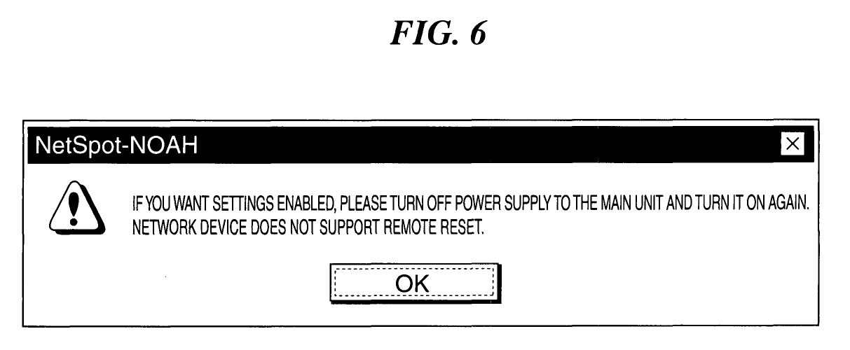

In the step S7, a message prompting the user to restart power supply to the device, as shown in FIG. 6, is displayed. If the reason of “Remote reset is not supported by the network device.” is displayed on a message display screen shown in FIG. 6, it is possible to provide the message helping the user more easily understand the situation. Then, the display of network setup sheet shown in FIG. 5 is deleted. The reason why the network setup sheet is deleted is that if the user carries out the configuring again via the setup sheet shown in FIG. 5 during restart of power supply to the network device, an error will occur to confuse the user.

In the step S9, an instruction for retrial of remote reset is issued because although the remote reset based on the MIB data is supported by the network device, the response of an error has been received from the network device due to a predetermined situation. By virtue of provision of the step S9, it is possible to make full use of the function of remote reset. Further, if a message prompting the user to select either retrial of the remote reset or manual restart of the power supply is displayed before execution of the step S9, a reset environment can be realized which meets the needs of the user in a more satisfactory manner. Moreover, if a message to the effect that remote reset could not be executed for a reason different from the reason causing the process to proceed to the step S7 is contained in a displayed message, the message helps the user more easily understand the situation.

Further, in the step S9, remote reset is executed in response to reception of an event issued by the network device after elimination of the cause of the error in the network device (printer). Thereafter, the process returns to the step S4.

The conditions of causing the network device to issue an event to the client computer may include absence of a job for printing reserved in a print queue of the network device, completion of test printing including sheet discharge, and completion of writing of a predetermined set value in the NVRAM. If the network device is not capable of issuing such an event, the client inquires the status of the network device by polling, and when the status of the network device obtained through the inquiry has become remote-resettable, the write request requesting writing of the MIB data for remote reset may be transmitted.

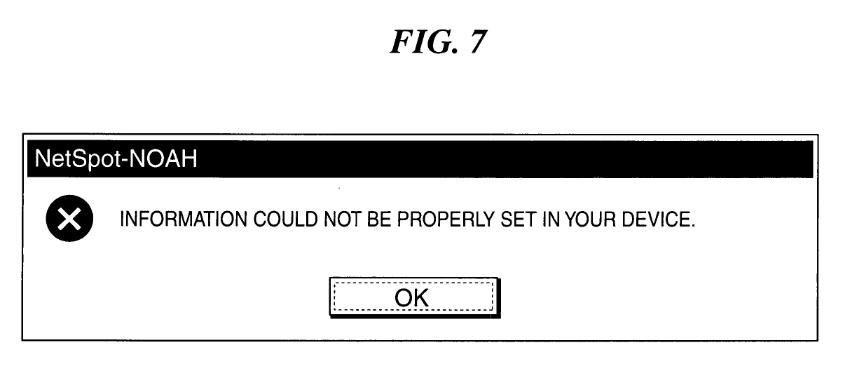

In the step S8, an error message, an example of which is shown in FIG. 7, to the effect that information could not be properly set in the network device is displayed.

Although in the present embodiment, when remote reset cannot be performed, the message prompting the user to restart power supply to the device is displayed, this is not limitative, but a request for restart of power supply to the device may be transmitted to the network device without displaying the message, or the network device controller 1 which can communicate with the printer 2 via the network 4 may be notified that a reset switch or the like provided in the device should be operated, to thereby notify the user of the necessary operation.

By thus carrying out the process shown in the FIG. 4 flowchart, even when devices to be configured include a device whose specifications for device configuring and reset operation are unknown, it is possible to provide means enabling the user to be efficiently prompted for reset of the device.

Further, what kind of MIB data writing by a write request for the MIB data has failed, i.e. whether data writing by the write request for the MIB data for remote reset or by the write request for other MIB data has failed is properly determined (S6, S3), so that it is possible to cause the client to display an appropriate warning message according to the kind of a request by which the writing has failed.

FIG. 8 is a flowchart showing a process executed by the network device in response to the above network device-setting process shown in FIG. 4. It is assumed that processing in each step is achieved through execution of a program stored in a storage, by a central processing unit (CPU) provided in the device.

In FIG. 8, first, the write request transmitted in the step S1 is received (S11), and it is determined whether or not it is possible to accept this write request (S12). The request for writing via the MIB is not limited to the instruction given via the network setup sheet shown in FIG. 5, but write requests of many other configuring instructions can be envisaged. Therefore, the determination in the step S12 includes a determination as to whether or not a request for any of various configuring instructions can be accepted.

If it is determined in the step S12 that the write request cannot be accepted, information indicative of failure is transmitted to the network device controller 1 (S13), whereas if the write request can be accepted, information indicative of success is transmitted to the network device controller 1 (S14).

Then, the write request transmitted in the step S4 is received (S15), and it is determined whether or not the write request is related to remote reset (S16).

If it is determined in the step S16 that the write request is related to remote reset, it is determined whether or not remote reset is possible to execute (S17). If remote reset is possible to execute, the reset operation is executed (S18), and at the same time information indicative of success is transmitted to the network device controller 1 (S19), whereas if remote reset is impossible to execute, information indicative of failure is transmitted to the network device controller 1 (S20). The latter information includes information from which the client can determine in the step S6 in FIG. 4 whether the process should proceed to the step S7 or to the step S9.

On the other hand, if it is determined in the step S16 that the write request is not related to remote reset, it is determined whether or not the write request is related to manual reset (S21).

If it is determined in the step S21 that the write request is related to manual reset, manual reset is executed by operation by the user (S22), whereas if the write request is not related to manual reset, the present process is terminated.

Although not shown, when writing of MIB data other than for remote reset has failed, notification control is executed so as to cause an indication similar to the message shown in FIG. 7 to be displayed on the client (S13 after NO to the step S12).

Further, although in the process described with reference to FIG. 4, the client determines what kind of write request has failed, another form of process may be contemplated in which the device notifies the client of what kind of MIB write request resulted in failure/success of processing thereof. In this case, after execution of the step S13, or after it is determined in the step S21 that the write request is not related to manual reset, information indicative of what kind of write request has resulted in failure of processing thereof may be notified, or information of whether processing of the request for remote reset has failed may be included in the information transmitted in the step S20. By causing the client to execute display control based on the information notified by the device, the above-mentioned other form of the process can be achieved.

As described heretofore, according to the present embodiment, it is not necessary to prepare a program depending on the types of devices, that is, depending upon whether the device is a type which can be remotely reset for enabling settings thereof and a type requiring a user to manually restart its power supply for the same purpose, which contributes to reduction of development costs.

Further, according to the present embodiment, even if in a network printing environment where printer devices of various models including new ones and old ones are used, there exist printer devices employing various reset methods, users need not learn in advance about correspondence between each device and a reset method or install a reset utility corresponding to a device-specific reset method in advance, but it is possible to realize a highly efficient printer device reset utility.

Although in the step S4 in FIG. 4, a remote reset instruction is given to the network device to forcibly cause the same to carry out remote reset, this not limitative, but an inquiry may be made, before the MIB data for remote reset is written, as to whether remote reset is supported by the network device. In this case, if it is confirmed that remote reset is supported, the process may proceed to the step S10, whereas if remote reset is not supported, the process may proceed to the step S7.

Further, the present invention may be applied to a system composed of a plurality of apparatuses (e.g. a host computer, interface devices, a reader, a printer, and so forth) or to a single apparatus (e.g. a facsimile machine or a copier).

It also goes without saying that the object of the present invention may be accomplished by supplying a system or apparatus with a storage medium in which a program code of software which realizes the functions of the above described embodiment, and causing a computer (CPU or MPU) of the system or apparatus to read out and execute the program code stored in the storage medium.

In this case, the program code itself read from the storage medium realizes the functions of the above described embodiment, and hence the storage medium on which the program code is stored constitutes the present invention.

Examples of the storage medium for supplying the program code include a floppy (registered trademark) disk, a hard disk, an optical disk, a magneto optical disk, a CD-ROM, a CD-R, a CD-RW, a DVD-ROM, a DVD-RAM, a DVD-RW, a DVD+RW, a magnetic tape, a nonvolatile memory card, and a ROM. Downloading via a network can also be utilized.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

What is claimed is:

1. An information processing apparatus capable of communicating with network devices each provided with a recording device for recording data on a recording medium, comprising:
a configuring device that gives a configuring instruction to a network device to be controlled, from a remote site, to thereby cause the network device to be configured;
a reset instruction device that gives a remote reset instruction to the network device to be controlled; and
a display control device that causes a message requesting restart of power supply to the network device and an indication of a successful remote reset to be selectively displayed on a display, based on response information output from the network device in response to the remote reset instruction given by the reset instruction device.

2. An information processing apparatus as claimed in claim 1, further comprising:
a reception device that receives the response information; and
a determination device that determines, based on the response information, whether or not processing carried out in response to the remote reset instruction given to the network device has been successful.

3. An information processing apparatus as claimed in claim 2, wherein said determination device is responsive to reception by said reception device receiving information indicating that remote reset is not supported by the network device, as the response information, for determining that the processing carried out in response to the remote reset instruction has failed.

4. An information processing apparatus as claimed in claim 3, wherein said determination device is responsive to said reception device receiving information indicating that the network device is in a state incapable of carrying out remote reset, as the response information, for determining that the processing carried out in response to the remote reset instruction has failed, the network device supporting remote reset.

5. An information processing apparatus as claimed in claim 4, wherein said reset instruction device is responsive to said reception device receiving the information indicating that the network device is in the state incapable of carrying out remote reset, for giving the remote reset instruction to the network device again.

6. An information processing apparatus as claimed in claim 2, wherein said reset instruction device is responsive to said determination device determining that the processing carried out in response to the remote reset instruction has failed, for giving the remote reset instruction to the network device again.

7. An information processing apparatus as claimed in claim 6, wherein said reception device also receives an event issued upon termination of a job being processed by the network device, and
wherein said reset instruction device gives the remote reset instruction to the network device again in response to reception of the event.

8. An information processing apparatus as claimed in claim 2, wherein said display control device is responsive to said determination device determining that the processing carried out in response to the remote reset instruction has been successful, for causing a state of progress of reset processing in the network device to be displayed on the display.

9. An information processing apparatus as claimed in claim 1, wherein said determination device determines whether or not processing carried out in response to the configuring instruction given by said configuring device has failed, and said display control device causes different messages to be displayed on the display depending on whether said determination device determines that the processing carried out in response to the configuring instruction given by said configuring device has failed or that processing carried out in response to the remote reset instruction has failed.

10. An information processing apparatus capable of communicating with network devices each provided with a recording device for recording data on a recording medium, comprising:
a configuring device that gives a configuring instruction to a network device to be controlled, from a remote site;
a reset instruction device that gives a remote reset instruction to the network device to be controlled, in accordance with the configuring instruction by said configuring device, so as to enable configuring of the network device by said configuring device;
a determination device that determines whether remote reset of the network device has failed or processing carried out by the network device in response to another instruction has failed; and
a display control device responsive to said determination device determining that remote reset of the network device has failed, for causing a message requesting restart of power supply to the network device to be displayed on a display.

11. An information processing apparatus as claimed in claim 10, wherein the other instruction includes the configuring instruction given to the network device by said configuring device, and said display control device is responsive to said determination device determining that the processing carried out by the network device in response to the other instruction has failed, for causing a message indicating that configuring of the network device by said configuring device has failed, to be displayed on the display.

12. A network device control method comprising:
a configuring step of giving a configuring instruction to a network device to be controlled, from a remote site, to thereby cause the network device to be configured;
a reset instruction step of giving a remote reset instruction to the network device to be controlled; and
a display control step of causing a message requesting restart of power supply to the network device and an indication of a successful remote reset to be selectively displayed on a display, based on response information output from the network device in response to the remote reset instruction given in said reset instruction step.

13. A network device control method comprising:
a configuring step of giving a configuring instruction to a network device to be controlled, from a remote site;
a reset instruction step of giving a remote reset instruction to the network device to be controlled, in accordance with the configuring instruction given in said configuring step, so as to enable configuring of the network device;
a determination step of determining whether or not remote reset of the network device has failed; and
a display control step of causing a message requesting restart of power supply to the network device to be displayed on a display, when it is determined in said determination step that remote reset of the network device has failed.

14. A program for causing a computer to execute a network device control method comprising:
a configuring step of giving a configuring instruction to a network device to be controlled, from a remote site, to thereby cause the network device to be configured;
a reset instruction step of giving a remote reset instruction to the network device to be controlled; and
a display control step of causing a message requesting restart of power supply to the network device and an indication of a successful remote reset to be selectively displayed on a display, based on response information output from the network device in response to the remote reset instruction given in said reset instruction step.

15. A program for causing a computer to execute a network device control method comprising:
a configuring step of giving a configuring instruction to a network device to be controlled, from a remote site;
a reset instruction step of giving a remote reset instruction to the network device to be controlled, in accordance with the configuring instruction given in said configuring step, so as to enable configuring of the network device;
a determination step of determining whether or not remote reset of the network device has failed; and
a display control step of causing a message requesting restart of power supply to the network device to be displayed on a display, when it is determined in said determination step that remote reset of the network device has failed.

16. A computer-readable storage medium storing a program for causing a computer to execute a network device control method comprising:
a configuring step of giving a configuring instruction to a network device to be controlled, from a remote site, to thereby cause the network device to be configured;
a reset instruction step of giving an instruction of remote reset to the network device to be controlled; and
a display control step of causing a message requesting restart of power supply to the network device and an indication of a successful remote reset to be selectively displayed on a display, based on response information output from the network device in response to the remote reset instruction given in said reset instruction step.

17. A computer-readable storage medium storing a program for causing a computer to execute a network device control method comprising:
a configuring step of giving a configuring instruction to a network device to be controlled, from a remote site;
a reset instruction step of giving a remote reset instruction to the network device to be controlled, in accordance with the configuring instruction given in said configuring step, so as to enable configuring of the network device;
a determination step of determining whether or not remote reset of the network device has failed; and
a display control step of causing a message requesting restart of power supply to the network device to be displayed on a display, when it is determined in said determination step that remote reset of the network device has failed.
